(19) United States
(12) Patent Application Publication
(10) Pub. No.: US 2018/0035215 A1
(43) Pub. Date: Feb. 1, 2018

(54) Protective Hearing Device

(71) Applicant: Alvis Watson Lewis, III, Waynesboro, VA (US)

(72) Inventor: Alvis Watson Lewis, III, Waynesboro, VA (US)

(21) Appl. No.: 15/220,620

(22) Filed: Jul. 27, 2016

(51) Int. Cl. H04R 25/00

(52) U.S. Cl. CPC H04R 25/505; H04R 2460/01

(57) ABSTRACT

A method and apparatus for enhancing and protecting hearing. Sounds may be amplified based on their frequencies, or sounds may be attenuated, based on their loudness. Communication between a hearing aid, external to the ear, and the earpiece is by conductor or by wireless technology. An earpiece is molded specifically for a wearer, and the speaker is molded into the molded earpiece. The combination provides enhanced hearing for those having hearing challenges, hearing protection due to loud noise attenuation and a well-fitted molded earpiece that restricts ambient sounds from entering the ear.

### BACKGROUND OF THE INVENTION

### Field of the Invention

The present invention relates generally to a hearing device. More particularly, the instant invention is a method and apparatus for coupling an existing hearing aid with a protective hearing device, able to amplify certain signals and attenuate loud sounds while physically blocking said loud sounds from the ear.

### Background Art

Many people of all ages and walks of life require hearing enhancement. Frequently, such enhancement takes the form of selective amplification. Present day hearing aids are designed to selectively amplify frequencies based on the patient's specific hearing challenges. For instance, a patient may have difficulty hearing high frequencies. Hence, a hearing aid for that patient would be programmed to amplify only high frequencies, while lower frequencies are passed at normal volumes. Hence, the operation of each hearing aid is programmed for a given patient.

Hearing protection has a long history. Blocking the ear canal with rags, cotton, or any manner of adequately deformable material is surely the most fundamental way to help reduce the impact of loud noises to the sensitive ear drum. Plugs are made of foam material that may be compressed then expands to block the ear. Plugs made of polymers to conform to a particular person's ear for hearing protection as well as reducing or eliminating water introduction while swimming are available. Ear muffs may be worn over the ears, and speakers may or may not be incorporated therein. Speakers can be used to play music, communicate with others remotely, or cancel sound.

Hearing aid wearers participate in the same activities as the general population, including those involving loud noises, such as mowing the lawn, running a chainsaw, circular saw, drill, grinder, or other tool, watching fireworks, etc. Another example is shown in Fig. 1a where a prior art hearing device 10 is worn while the wearer 20 shoots a firearm 30. Until now, protecting a hearing aid wearer's hearing has precluded engaging in a normal conversation between the loud noises associated with these activities, such as between shots on the firing range.

Another prior art hearing enhancement system is shown in Fig. 1b. This device comprises a hearing aid 40 and a molded earpiece 50. In this prior art assembly, a speaker (not shown) is housed inside the hearing aid 40. The sounds emitted by the speaker are communicated to the earpiece 50 via a hollow tube 60.

For those who wear hearing aids, there is a paucity of viable options for both enhanced hearing and hearing protection. There is, therefore, a need for a hearing aid and hearing protection combination.

### BRIEF SUMMARY OF THE INVENTION

An object of the present invention is to provide a method and apparatus for providing hearing protection for those who wear hearing aids. An additional object is to minimize the cost of the apparatus.

For the purposes of the present document, including the claims, the following terms are defined: the term hearing aid is hereby defined as a portion of a hearing enhancement device external to the ear, usually worn behind the ear or on eyeglasses. The hearing aid typically comprises at least one microphone and at least one microprocessor for processing the signals detected by the microphone. Operator controls and a power source are also incorporated into the hearing aid.

The term earpiece is hereby defined as an insert to the ear. The earpiece fits at least partially into the ear canal. Specifically, the hearing aid is remote from the earpiece. The earpiece comprises a speaker, actuated electrically, by which sounds may be amplified.

The term wireless technology is hereby defined to mean the use of electromagnetic waves, such as radio frequency, for communication without the use of conductors. LTE, LTE-Advanced, Wi-Fi, Bluetooth are some common modern wireless technologies at the time of this writing. In particular, wireless technology does not include sound (pressure) waves passing through a solid or fluid medium such as a hollow tube filled with air.

The term deletion when referring to a sound artifact is hereby defined as not reproducing any part of that sound. Deletion is an extreme form of attenuation. A hearer may still hear the loud sound via vibrations through the earpiece, but the speaker is not actuated to reproduce that sound.

Earpieces provided with standard hearing aids intentionally do not effectively block the ear canal. Ambient noise is still introduced into the ear naturally this way.

A hearing aid is typically programmed especially for a given patient based on that patient's hearing needs. Usually, not all frequencies are amplified—only those the wearer has difficulty hearing as determined by an audiologist or other hearing specialist. Sounds at other frequencies may pass directly into the ear from the ambient, or may enter the ear via the speaker, or both.

In one embodiment of the instant invention, the earpiece speaker is in communication with the hearing aid via a wire conductor. In another embodiment, the hearing aid and speaker are outfitted with wireless technology, so there is no physical connection between the two. In either embodiment, the earpiece is made of a moldable material known by those skilled in the art, such as that disclosed by Kirkpatrick in published U.S. Patent Application 2013/0216086, which is hereby incorporated in its entirety by reference.

Such an earpiece is formed to fit a given wearer, and is made to block ambient sounds from entering the ear canal. In the instant invention, all sounds must enter the ear via the speaker associated with the earpiece, hence, the speaker is molded into the earpiece. The hearing aid does not comprise a speaker.

Because hearing aids comprise a microprocessor, they may be programmed to attenuate loud sounds, as well as amplify certain frequencies. Loud sounds, those exceeding a given decibel level at any frequency, may be attenuated or even disallowed to activate the speaker associated with the earpiece entirely—or canceled. Combining this feature of the hearing aid—the standard hearing aid the wearer may wear every day—with the ear canal blocking capability of the molded earpiece, the wearer's hearing may be enhanced as well as protected. Hence, when shooting firearms at a shooting range, the report of the firearm is greatly diminished, while the hearing device wearer may still be able to carry on a conversation between shots.

### BRIEF DESCRIPTION OF THE SEVERAL VIEWS OF THE DRAWINGS

Fig. 1a depicts a perspective view of a prior art form of a hearing enhancement device in a firearm shooting setting;

Fig. 1b illustrates a perspective view of a prior art version of a hearing enhancement device;

FIG. 2 depicts a hearing enhancement device wearer in a firearm shooting setting wearing the hearing enhancement system of the instant invention;

FIG. 3 shows a perspective view of a first embodiment of the present invention wherein a speaker is molded into the molded earpiece to be disposed innermost in the ear canal;

FIG. 4 depicts a perspective view of the off-the-shelf—hence, prior art—form of the hearing enhancement device providing a basis for the present invention;

FIG. 5 illustrates the hearing aid being used with the original, off-the-shelf earpiece and the molded earpiece of first embodiment of the present invention;

FIG. 6 shows a perspective view of a second embodiment of the present invention wherein a speaker is molded within the molded earpiece;

FIG. 7 illustrates the hearing aid being used with the original, off-the-shelf earpiece and the molded earpiece of second embodiment of the present invention;

FIG. 8a illustrates a perspective view of a hearing aid fitted with wireless technology;

FIG. 8b depicts a perspective view of the off-the-shelf form of the earpiece outfitted with wireless technology to intercept wireless signals from the hearing aid shown in FIG. 8a;

FIG. 8c shows the first embodiment of the molded earpiece, including wireless technology to intercept wireless signals from the hearing aid shown in FIG. 8a;

FIG. 8d shows the second embodiment of the molded earpiece, including wireless technology to intercept wireless signals from the hearing aid shown in FIG. 8a;

FIG. 9a depicts a sound signal in graphical form having a loud artifact;

FIG. 9b depicts the same sound signal as that in FIG. 9a in graphical form wherein the loud artifact has been attenuated;

FIG. 9c depicts the same sound signal as that in FIG. 9a in graphical form wherein the loud artifact has been blocked or canceled; and

FIG. 10 is a flow chart illustrating the process of enhancing sounds for the hearer.

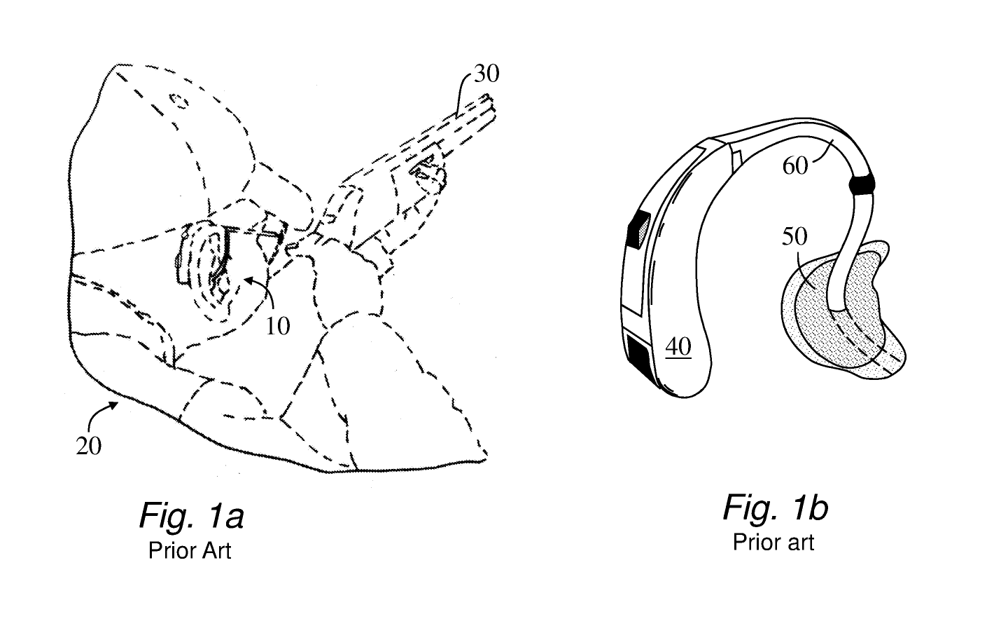

### DETAILED DESCRIPTION OF THE INVENTION

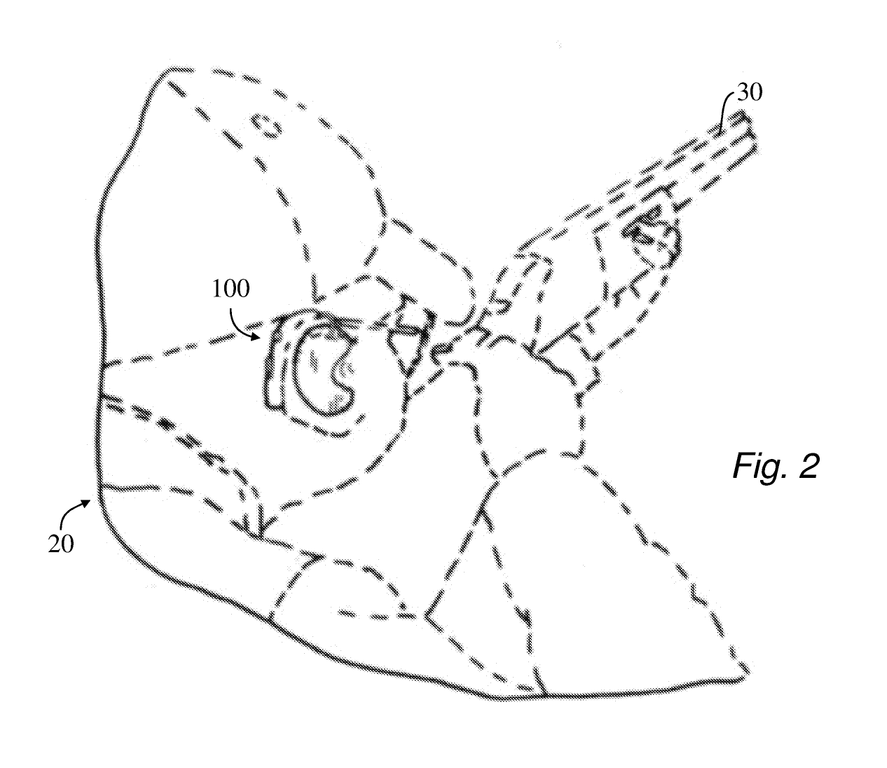

Referring now to the drawings wherein like reference numerals indicate identical or corresponding parts throughout the several views, a hearing enhancement device 100 is shown in FIG. 2, worn by a shooter of a firearm 30. Although the present invention is well suited to use on a firing range, its use is not limited thereto. The experience of any activity involving loud noises, such as weed trimming, leaf blowing, lawn mowing, wood cutting, tool and machinery operation, attending fireworks, etc. is improved by the instant invention.

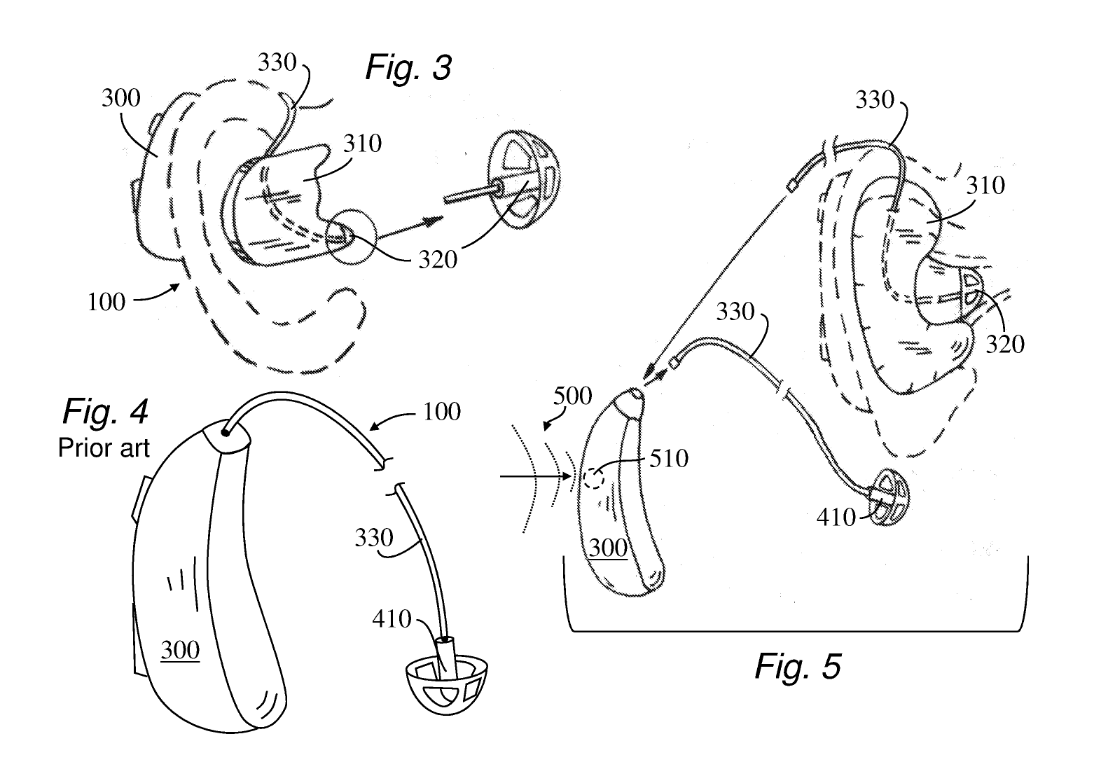

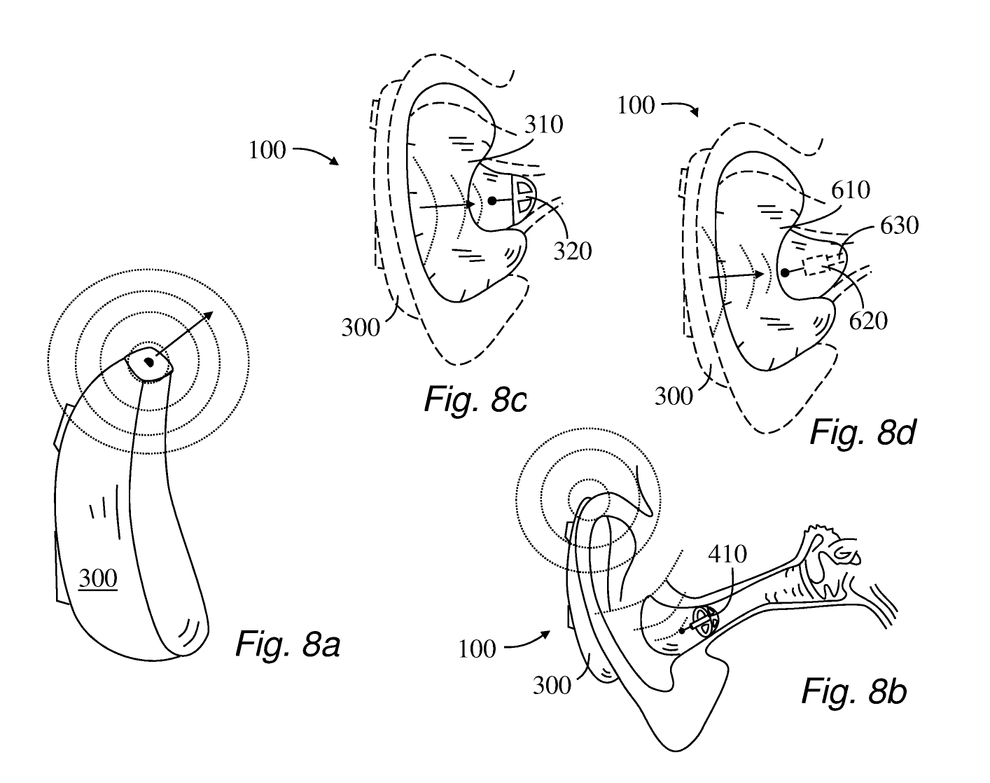

As can be seen in FIGS. 3-8d, the hearing enhancement device 100 includes a hearing aid 300, an earpiece 310, 410, 610, the earpiece further comprising a speaker 320, 620. Said speaker 320, 620 is electrically actuated, and is not due to an air passageway from a speaker in the hearing aid 300. In one embodiment of the present invention, the hearing aid 300 and the speaker 320, 620 associated with the earpiece 310, 410, 610 are in communication via a physical connection 330, such as a conductor or wire, or a fiber optics cable. In a second embodiment of the present invention, depicted in FIGS. 8a-8d, the hearing aid 300 communicates with the speaker 320, 620 via wireless technology, for example, Bluetooth.

The earpiece 310, 610 of the embodiments of the present invention is molded to fit a particular wearer 20. Materials, processes, and technology associated with creating molded earpieces 310, 610 are well known in the art. Typically, plastically-deformable material is pressed into and around the wearer's 20 ear canal. The material is put through a process involving heat and or chemicals that renders the material elastically-deformable. The resulting earpiece 310, 610 fits only the wearer's 20 ear used to produce the earpiece 310, 610. The molded earpiece 310, 610 has an advantage over the non-molded earpiece 410 provided with prior art hearing enhancement devices 100 in that the molded earpiece 310, 610 physically blocks ambient noise.

The speaker 320 of FIGS. 3, 5, and 8c, is molded into the portion of the earpiece 310 innermost in the ear canal. It is depicted in the figures much like the earpiece 410 of the prior art. However, the non-molded earpiece 410 of the prior art may comprise different material and geometry for comfort and stability not required in the speaker 320 because the molded earpieces 310 may be depended upon for those attributes.

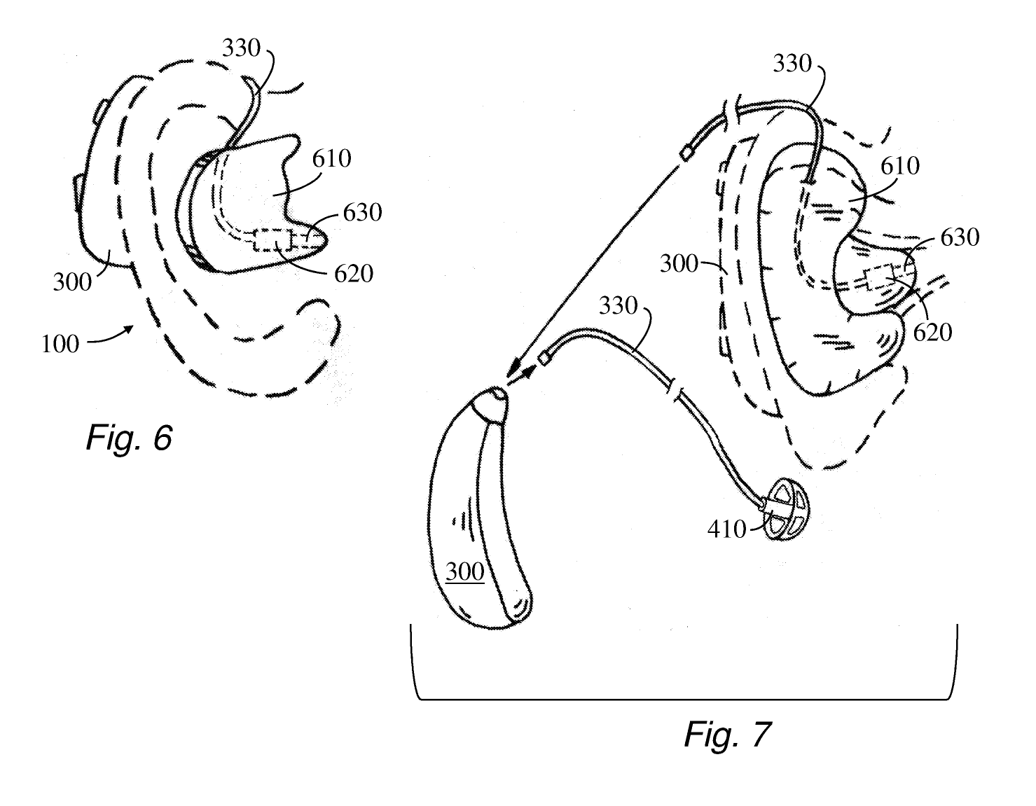

An alternate embodiment for the speaker 620 is shown in FIGS. 6, 7, and 8d. Here, the speaker 620 is molded within the molded earpiece 610 and an air passageway 630 provides a path for the sound waves—or pressure pulses—to travel into the ear.

Sound 500 comprises infinitesimal pressure pulses. That sound 500 is received by a microphone 510, internal or external to the hearing aid 300. The sound 500 is converted into sound data in the microprocessor 1020 (see FIG. 10) associated with the hearing aid 300. The sound data are analyzed and modified as needed. Modifications include amplification or attenuation, depending on the amplitude of the sound and its frequency. The modified sound data are then communicated, ultimately, to the speaker 320, 620 within the hearer's 20 ear and converted to sounds said hearer 20 can hear.

Communicating sound data from the hearing aid 300 to the speaker 320, 620 is via a wire conductor 330 in FIGS. 3-7, irrespective of the location of the speaker 320, 620 with respect to the earpiece 310, 610, and via wireless technology in FIGS. 8a-8d, irrespective of the location of the speaker 320, 620 with respect to the earpiece 310, 610.

Wireless technology for communicating sound data from the hearing aid 100 to the speaker 320, 620, as shown in FIGS. 8a-8d, makes use of electromagnetic waves to transmit the audio that is translated to sound by the speaker 320, 620. Flexibility for the location of the hearing aid 300 is an advantage to using wireless technology. The hearing aid may be attached to the wearer's 20 eyeglasses, worn in a shirt, blouse, or dress pocket, attached to a belt, etc. Typically the hearing aid 100 is disposed in the vicinity of the ear to pick up sounds most naturally. However, the present invention is not limited to the disposal of the hearing aid 100 in any particular location except that it is disposed remotely with respect to the earpiece 310, 410, 610.

An advantage of the instant invention is cost-savings and familiarity due to the use of the wearer's 20 own hearing aid 300. Typically, the hearing aid 300 is that worn regularly by the wearer 20, and is programmed for that wearer's 20 hearing challenges. The stock, off-the-shelf earpiece 410 and its wire 330 may be unplugged from the hearing aid 300 and the molded earpiece of the present invention 310, 610 and its wire 330 plugged into the hearing aid 300 when the wearer 20 expects to be exposed to loud noises. The active program in the hearing aid 300 may be changed to one that attenuates loud noises at that time if the wearer 20 usually uses a program that does not attenuate such loud noises. Importantly, the molded earpiece 310, 610 physically blocks ambient noise from the ear canal.

For each hearing enhancement device 100 wearer, certain signals or frequencies are amplified due to hearing loss associated with those signals or frequencies. The hearing aid 300 contains at least one microprocessor 1020 by which the hearing aid 300 is programmed by an audiologist, or other hearing specialist.

Loud noises may be attenuated to reduce the number of decibels reaching ear as disclosed in published U.S. Patent Application 2013/0051590 by Slater, which is herein incorporated in its entirety by reference. Loud noises may also simply not be reproduced at all by the speaker 320, 620, which is an extreme form of attenuation and defined herein as sound deletion. Loud noises may also be canceled by applying an anti-noise wave to deaden even the ambient sound passing through the moldable earpiece 310, 610. Noise cancelation, or active noise control, is described by Wikipedia as: “Adaptive algorithms are designed to analyze the waveform of the background aural or nonaural noise, then based on the specific algorithm generate a signal that will either phase shift or invert the polarity of the original signal. This inverted signal (in antiphase) is then amplified and a transducer creates a sound wave directly proportional to the amplitude of the original waveform, creating destructive interference. This effectively reduces the volume of the perceivable noise.” (https://en.wikipedia.org/wiki/Active_noise_control.)

Loud noises may be defined for the purpose of programming the microprocessor 1020 in the hearing aid 300 to be any noise exceeding a given decibel level. The attenuation may vary depending on the decibel level and/or the frequency of the loud noise.

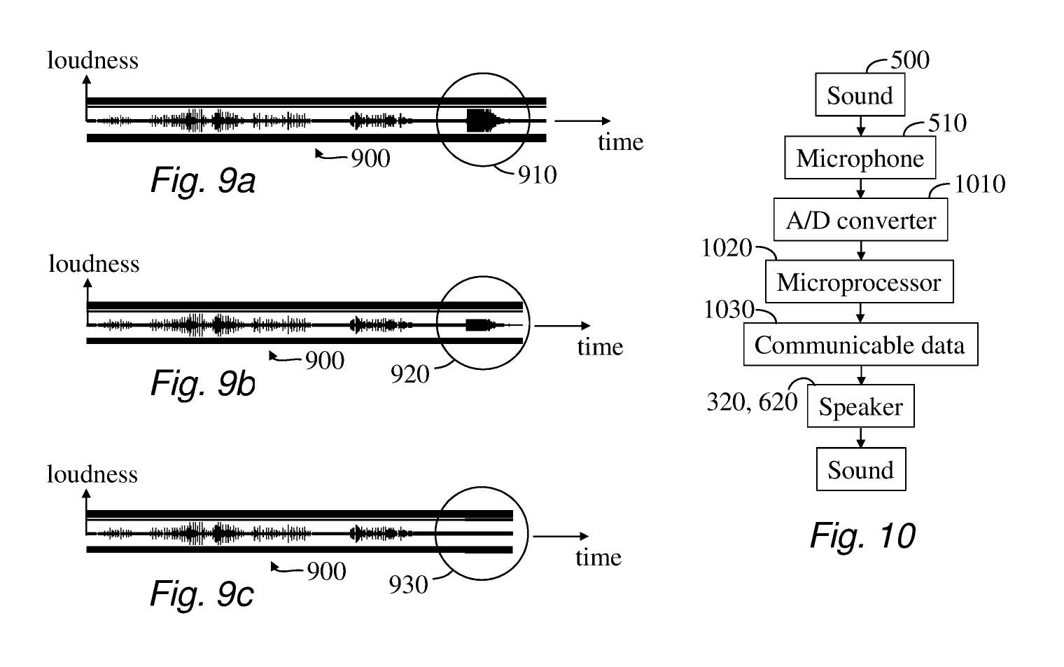

In FIGS. 9a and 9b, a sound signal 900 is shown in graphical form where the abscissa is time and the ordinate is an amplitude or loudness of the sound signal 900. The amplitude may be shown in decibels or in percent or fraction of a given amplitude.

There is a loud artifact 910 in the sound signal 900 of FIG. 9a shown in the circle. The remainder of the sound signal 900 was produced from speech at a comfortable conversation level. The loud artifact 910 has been attenuated in FIG. 9b. A hearer would still be able to hear the attenuated loud artifact 920 shown in the circle. However, the amplitude of the attenuated loud artifact 920 is no greater than some of the amplitudes produced in normal speech. So the attenuated loud artifact 920 is not dangerous to the hearer 20.

In FIG. 9c, the loud artifact 910 shown in FIG. 9a has been deleted by the hearing enhancement system 100. Consider that the sound signal of FIG. 9c represents what is heard by the hearer 20. The loud artifact 910 of FIG. 9a may have been deleted or canceled by the hearing enhancement system 100.

The process of enhancing sound for a hearer 20 is outlined in FIG. 10 by a flowchart. Ambient sound 500 enters the microphone 510 of the hearing aid 300 where an analog electrical signal representing the sound 500 is created. The analog electrical signal is typically digitized via at least one analog to digital (A/D) converter 1010, although analog signals may also be worked with. The digitized signal is then usable by the microprocessor 1020. Within the microprocessor 1020, the data may be enhanced by amplifying some signals, particularly frequencies the hearer 20 has difficulty hearing, and by attenuation of loud sounds that could be harmful to the hearer 20.

The result of the enhancement process must be communicable sound data 1030 that may be transmitted to the speaker 320, 620 which, in turn, produces sound within the hearer's 20 ear.

The above embodiments are the preferred embodiment, but this invention is not limited thereto, nor to the figures and examples given above. It is, therefore, apparent that many modifications and variations of the present invention are possible in light of the above teachings. It is, therefore, to be understood that within the scope of the appended claims, the invention may be practiced otherwise than as specifically described.

1. A method of providing hearing enhancement and hearing protection, the method comprising:
(a) programming a microprocessor associated with a hearing aid to amplify specific signals;
(b) programming the microprocessor associated with the hearing aid to attenuate loud noises;
(c) constructing a custom molded earpiece;
(d) molding a speaker in the custom molded earpiece;
(e) operatively disposing the custom molded earpiece into an ear;
(f) receiving sound into the hearing aid;
(g) converting the sound into communicable sound data by the microprocessor associated with the hearing aid;
(h) modifying at least some of the sound data by the microprocessor associated with the hearing aid;
(i) communicating the sound data from the hearing aid using a communication mode selected from the group consisting of wired communication and wireless technology;
(j) operatively receiving said sound data at the speaker; and
(k) converting the sound data to sound by the speaker.

2. The method of claim 1 wherein loud noises are defined as noises exceeding a predetermined decibel level.

3. The method of claim 1 additionally comprising:
(a) obtaining a non-molded earpiece comprising a second speaker;
(b) operatively disposing the non-molded earpiece into the ear;
(c) receiving the sound data at the speaker associated with the non-molded earpiece;
(d) ceasing to communicate sound data from the hearing aid to the second speaker;
(e) removing the non-molded earpiece from the ear; and
(f) switching a program in the microprocessor associated with the hearing aid.

4. The method of claim 1 wherein programming the microprocessor associated with the hearing aid to attenuate loud noises comprises programming the hearing aid to reduce an amplitude of loud noises.

5. The method of claim 1 wherein modifying at least some of the sound data in the microprocessor associated with the hearing aid comprises modifying loud sounds in a manner selected from the group consisting of attenuation, deletion, and cancelation.

6. The method of claim 1 wherein molding the speaker in the custom molded earpiece comprises:
(a) disposing the speaker in a location selected from the group consisting of a first position that will lie innermost in a wearer's ear canal and a second position within material from which the custom molded earpiece is made, not innermost in a wearer's ear canal; and
(b) operatively forming the material from which the custom molded earpiece is made around at least a portion of the speaker.

7. The method of claim 1 wherein modifying at least some of the sound data by the microprocessor associated with the hearing aid comprises amplifying at least some of the sound data.

8. The method of claim 1 wherein modifying at least some of the sound data by the microprocessor associated with the hearing aid comprises attenuating at least some of the sound data.

9. An apparatus for hearing enhancement and hearing protection comprising:
(a) a hearing aid;
(b) a microphone associated with the hearing aid to convert a first sound to an electrical signal;
(c) a microprocessor to amplify the first sound at predetermined frequencies and to attenuate loud sounds;
(d) a custom molded earpiece fitted to a wearer's ear; and
(e) a speaker to create a second sound that the wearer hears, said speaker being molded into the custom molded earpiece.

10. The apparatus of claim 9 additionally comprising an analog to digital converter to convert the electrical signal to a digital signal usable by the microprocessor.

11. The apparatus of claim 9 additionally comprising an electrical conductor to communicate sound data from the hearing aid to the speaker.

12. The apparatus of claim 9 additionally comprising wireless technology to communicate sound data from the hearing aid to the speaker.

13. The apparatus of claim 9 wherein the speaker is molded into the custom molded earpiece in a location selected from the group consisting of a first position that will lie innermost in a wearer's ear canal and a second position within material from which the custom molded earpiece is made, not innermost in a wearer's ear canal.

14. The apparatus of claim 13 additionally comprising an air passage connecting the speaker and an ear canal of the wearer.

15. The apparatus of claim 9 wherein the custom molded earpiece comprises an elastically deformable material fitted to one ear of the wearer and into which the speaker is molded, an outer portion of said custom molded earpiece being the same shape as at least a portion of a user's ear canal whether the custom molded earpiece is in or out of the user's ear canal.

16. The apparatus of claim 15 wherein is constructed of a non-foam plastic material.

17. The method of claim 6 including making the custom molded earpiece of a deformable, non-foam, material into the shape of at least a portion of a user's ear canal whether or not the custom molded earpiece is in the user's ear canal or not.

18. The method of claim 6 including making the custom molded earpiece of a plastically-deformable material by pressing the material into and around the user's ear canal and using heat and or chemicals to render the material elastically-deformable non-foam earpiece that remains the shape of the user's ear canal when removed from the user's ear.
